(19) United States
(12) Patent Application Publication
(10) Pub. No.: US 2007/0153338 A1
(43) Pub. Date: Jul. 5, 2007

(54) Loading and unloading apparatus for recording medium and image photographing and reproducing apparatus having the same

(75) Inventors: Jae-kab Seo, Suwon-si (KR); Bong-joo Kim, Suwon-si (KR); Jeong-hyeob Oh, Anyang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/431,031

(22) Filed: May 10, 2006

(30) Foreign Application Priority Data
Jan. 3, 2006 (KR) 2006-0000524

(51) Int. Cl. H04N 1/04

(52) U.S. Cl. 358/498

(57) ABSTRACT

A loading and unloading apparatus for a recording medium to detachably load a recording medium to an electronic device. A loading frame is installed in the electronic device and with which the recording medium is slidingly engaged. A connector is installed on the loading frame. An unloading unit is slidingly inserted in the loading frame and unloads the recording medium connected to the connector by a predetermined distance to separate the recording medium from the connector.

### CROSS-REFERENCE TO RELATED APPLICATIONS

This application claims the benefit under 35 U.S.C. § 119(a) of Korean Patent Application No. 2006-00524, filed on Jan. 3, 2006, the entire contents of which are hereby incorporated by reference.

### BACKGROUND OF THE INVENTION

1. Field of the Invention

The present invention relates to a loading and unloading apparatus for a recording medium that can selectively load and unload a recording medium to and from electronic device electronic devices, and an image photographing and reproducing apparatus having the same.

2. Description of the Related Art

Recently, mobile electronic devices, such as camcorders, digital cameras and mobile phones, have been introduced in various forms. These mobile electronic devices have become lighter, more compact and slimmer for convenient carrying.

These mobile electronic devices generally employ a CF (compact flash) memory card or a light-weight hard disk drive (HDD) as a recording medium that can record and reproduce photographed images.

When the recording medium is built into the electronic devices, it is inconvenient to be upgraded, exchanged and compatible with another devices.

Accordingly, there is a need for the recording medium to be selectively loaded and unloaded to and from the electronic devices so that it may be convenient to store, move, exchange and upgrade the recording medium and to offer warranty service thereto.

### SUMMARY OF THE INVENTION

An aspect of the present invention is to provide a loading and unloading apparatus for a recording medium that easily loads and unloads a recording medium to and from an electronic device, and an image photographing and reproducing apparatus having the same.

A loading and unloading apparatus for a recording medium detachably loads a recording medium to an electronic device. The loading and unloading apparatus includes a loading frame that is installed in the electronic device and with which the recording medium is slidingly engaged. A connector is installed on the loading frame. An unloading unit, which is slidingly inserted in the loading frame and unloads the recording medium, is connected to the connector by a predetermined distance to separate the recording medium from the connector.

The loading frame may include a first frame and a second frame that are engaged to face each other to slidingly insert and unload the recording medium therebetween.

The first frame may include a pair of first elastic pieces to elastically support opposite sides of the recording medium.

The first frame may further include a pair of second elastic pieces that elastically support one surface of the recording medium to restrain up and down movements.

The first frame may be made of a metal material.

The second frame may be engaged with the first frame to obtain a space to insert the recording medium therebetween, and has an opening to pass the connector therethrough.

Opposite sides of the recording medium may have sliding grooves having different shapes, respectively. The second frame has guide ribs corresponding to each of the sliding grooves of the recording medium.

The connector may include a flexible printed circuit (FPC) part connected to the loading frame, a connecting pin formed at an end portion of the FPC part to be located inside of the loading frame, and a contact bracket that fixes the connecting pin to become closed contact with the inside of the loading frame.

The connector may further include a reinforcement plate that is engaged with an end portion of the FPC part to oppose the connecting pin.

The unloading unit may include a rotating unit that is rotatably engaged with the loading frame to push and unload the recording medium loaded on the loading frame by a predetermined distance when rotated in one direction, and a sliding unit that is reciprocally, movably engaged with the loading frame to rotate the rotating unit in the one direction when moved in a loading direction of the recording medium.

The rotating unit may include a first rotating member that is rotatably engaged with the loading frame and one end of which is moved in association with the sliding unit, and a second rotating member that is rotatably engaged with the loading frame and rotated in association with the first rotating member.

The first rotating member and the second rotating member each may include pressurizing portions that are bent to simultaneously push opposite edges of the recording medium.

The first rotating member and the second rotating member may be rotatably engaged with the loading frame to be returned to original positions by the recording medium loaded on the loading frame from positions where the recording medium is unloaded.

The sliding unit may include a sliding bar that is reciprocally slidingly engaged in first and second directions with the loading frame, an interference lever that is rotatably engaged with one end of the sliding bar and interferes with the rotating unit to be rotated when moved in the first direction, a spring that elastically supports the sliding bar in the second direction, a cam member that changes a rotating angle to guide the interference lever to not be interfered by the rotating member when the interference lever is returned to the second direction, and a cover member that supports the sliding bar and the cam member and is engaged with the loading frame.

One end of the spring may be engaged with the cover member and the other end of the spring may be engaged with the interference lever. The interference lever may be pressurized in a direction to be out of a position where the interference lever interferes with the rotating unit by an elastic force of the spring.

The other end of the interference lever may include a cam pin that is inserted in a cam slit of the cam member to be guided and a contact portion that is bent to contact and rotate the rotating unit when moved in the first direction.

The cam member may include a cam slit, which is connected to a cam pin formed the other end of the interference lever, to guide the cam pin in one direction along a certain passage, and a cam surface formed in a certain shape on a bottom surface of the cam slit to guide the interference lever to move only in one direction of the cam slit in accordance with a reciprocal movement of the sliding bar.

When the sliding bar is firstly pushed in the first direction and released, the cam surface may guide the cam pin of the interference lever to move in the first direction, rotate the rotating unit and move out of an interference range of the rotating unit. When the sliding bar is secondly pushed in the first direction and released, the cam surface may guide the cam pin to move in the first direction and then in the second direction and return to an initial position.

The cover member may include an elastic piece that elastically pressurizes the interference lever toward the cam member.

The recording medium may include a hard disk drive. Additionally, the recording medium may include a CF memory card.

An image photographing and reproducing apparatus includes an image photographing apparatus body, a camera part that is formed at the body to photograph an image, a display unit that is formed at the body to display the image photographed by the camera part, and an unloading and unloading apparatus for a recording medium that is formed at the body to detachably load a recording medium that records image data photographed by the camera part and reproduces the recorded data.

The loading and unloading apparatus for a recording medium may include a loading frame that is installed in the electronic device and with which the recording medium is slidingly engaged. A connector is formed on the loading frame. An unloading unit, which is slidingly inserted in the loading frame and unloads the recording medium, is connected to the connector by a predetermined distance to separate the recording medium from the connector.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a perspective view of a loading and unloading apparatus for a recording medium according to an exemplary embodiment of the present invention;

FIG. 2 is an exploded perspective view of the loading and unloading apparatus for a recording medium of FIG. 1;

FIG. 3 is a partial elevational view in cross section of a recording medium of FIG. 2;

FIG. 4 is a perspective view of a first frame of the loading and unloading apparatus for a recording medium according to an exemplary embodiment of the present invention;

FIG. 5A is a perspective view of a loading and unloading apparatus for a recording medium according to an exemplary embodiment of the present invention when a recording medium is being loaded;

FIG. 5B is a perspective view of a recording medium being unloaded by a predetermined distance;

FIGS. 6A and 6B are exploded perspective views of a sliding unit of a loading and unloading apparatus for a recording medium according to an exemplary embodiment of the present invention;

FIG. 7A is a side elevational view of a cam member of FIG. 6A;

FIG. 7B is a schematic view of a cam surface of a cam slit of FIG. 7A; and

FIG. 8 is a schematic perspective view of an image photographing and reproducing apparatus according to an exemplary embodiment of the present invention.

Throughout the drawings, like reference numerals will be understood to refer to like parts, components and structures.

### DETAILED DESCRIPTION OF EXEMPLARY EMBODIMENTS

The matters defined in the description, such as a detailed construction and elements thereof, are provided to assist in a comprehensive understanding of the exemplary embodiments of the invention. Accordingly, those of ordinary skill in the art will recognize that various changes and modifications of the embodiments described herein may be made without departing from the scope and spirit of the invention. Also, descriptions of well-known functions and constructions are omitted for clarity and conciseness.

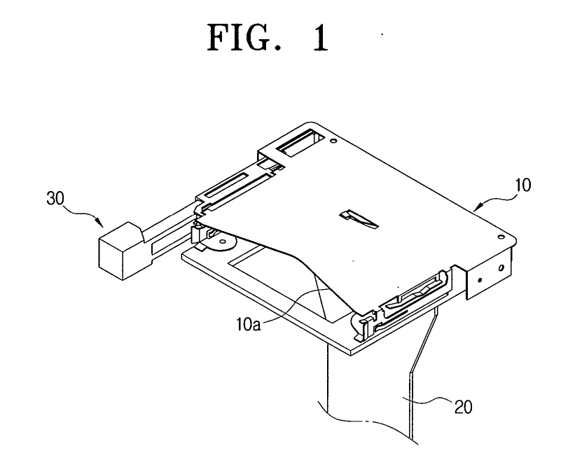

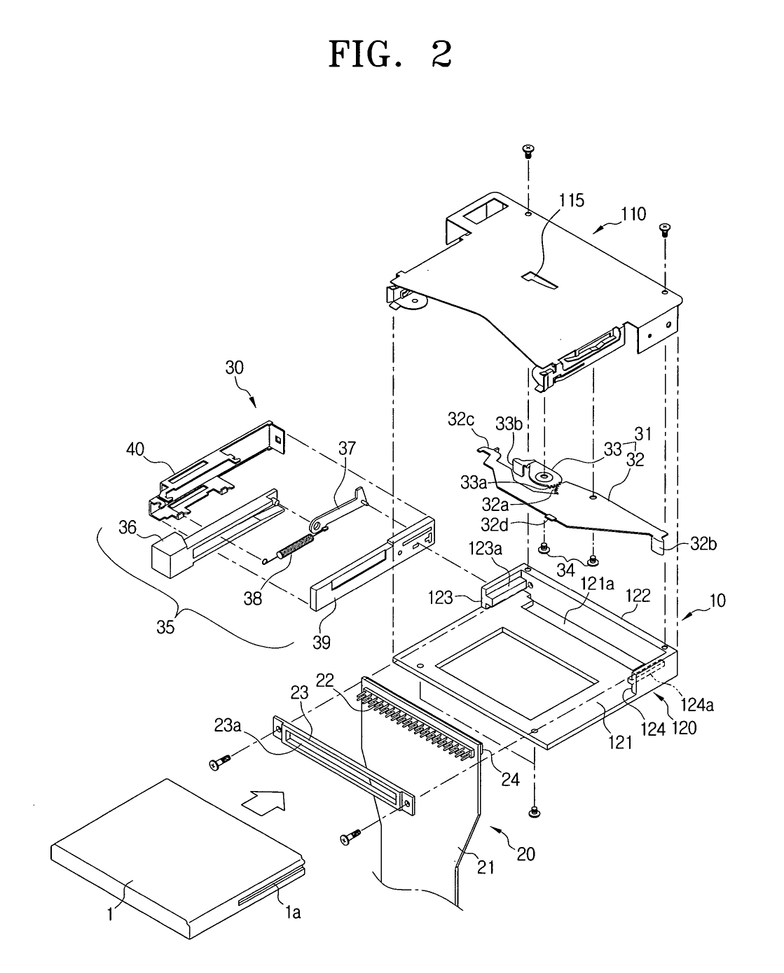

Referring to FIGS. 1 and 2, a loading and unloading apparatus for a recording medium according to an exemplary embodiment of the present invention for loading and unloading a recording medium 1, such as a hard disk drive (HDD) or a CF (compact flash) memory card, to and from an electronic device, such as a camcorder or a digital camera, includes a loading frame 10 to which the recording medium 1 is slidingly loaded, a connector 20 provided in the loading frame 10, and an unloading unit 30 separating the recording medium 1, which is loaded to the loading frame 10 and engaged with the connector 20, from the connector 20 to unload from the loading frame 10 by a predetermined distance.

The recording medium 1 is exemplified as a 1-inch hard disk drive 1. The recording medium 1 (hereinafter, a hard disk drive) is compact and light-weight and may have the same size and connecting structure as the CF memory card. Preferably, the hard disk drive (HDD) 1 may be removable rather than built in, and the memory card may employ CF type in the present exemplary embodiment.

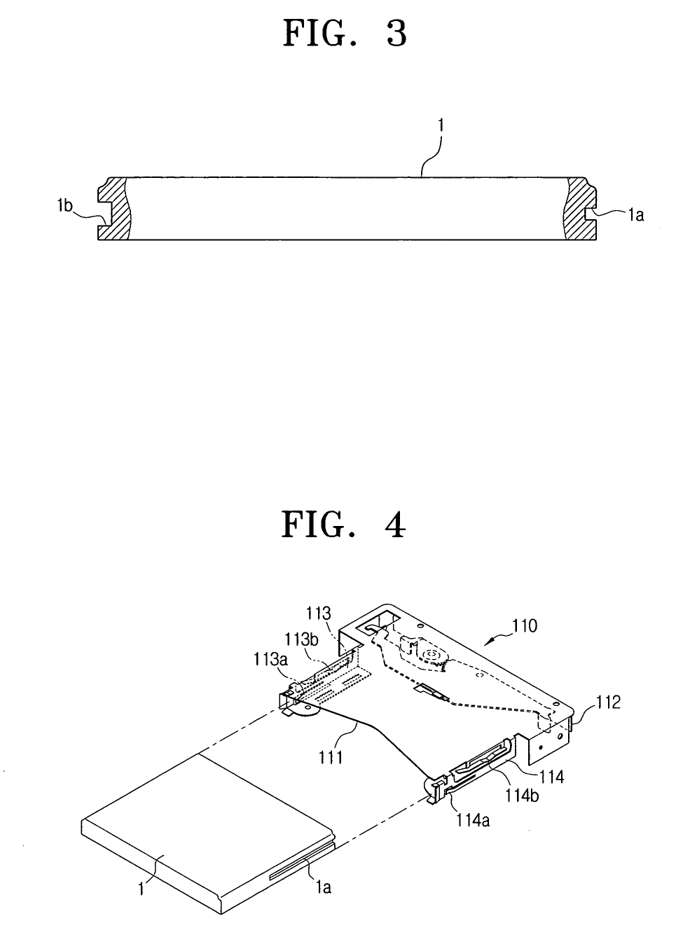

As shown in FIG. 3, the HDD 1 has sliding grooves 1a and 1b at opposite sides, respectively. The sliding grooves 1a and 1b have different widths so that up and down of the HDD 1 are prevented to be exchanged when loaded, that is, proper insertion of the inserted recording medium is ensured by providing sliding grooves of different widths.

The loading frame 10 that is mounted in an electronic device, such as a camcorder and a digital camera, includes a first frame 110 and a second frame 120 that are engaged with each other.

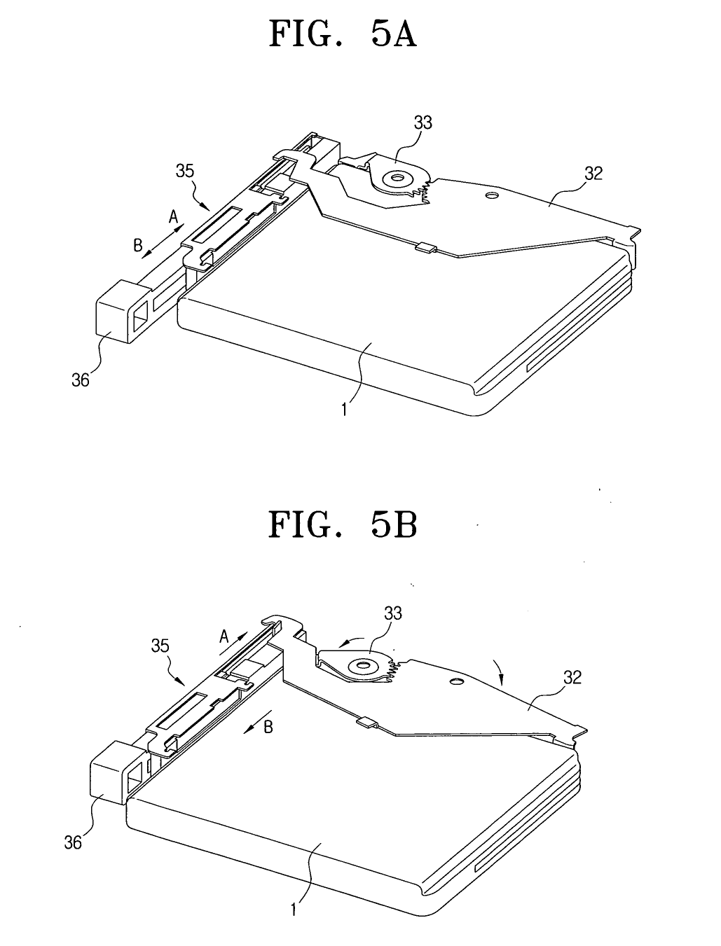

The first frame 110 is made of a metal material and has a certain shape by pressing. Preferably, the first frame 110 has a substantially square frame with a first horizontal portion 111 of a plate type, a first rear wall portion 112 bent at one side of the first horizontal portion 111 and first guide walls 113 and 114 bent in certain forms at opposite sides of the first horizontal portion 111 as shown in FIG. 4. The HDD 1 may be slid between the first guide walls 113 and 114 to be loaded onto the first rear wall portion 112. First elastic pieces 113a and 114a are formed to oppose each other at each first guide wall 113 and 114 to elastically support the opposite end portions of the HDD 1 when the HDD 1 is loaded. The first elastic pieces 113a and 114a substantially prevent the HDD 1 from moving left and right as loaded.

The first guide walls 113 and 114 each have second elastic pieces 113b and 114b to substantially prevent the HDD 1 from moving up and down.

The second frame 120 is engaged with the first frame 110 by fasteners, such as screws. The second frame 120 may be made of any suitable material, such as plastic by molding. The second frame 120 includes a second horizontal portion 121 to support one surface of the HDD 1, a second rear wall portion 122 and second guide walls 123 and 124. The second horizontal portion 121 includes a second opening 121a to connect with the connector 20. The second rear wall portion 122 is engaged with the connector 20 to support the connector 20. The second guide walls 123 and 124 are bent from the second horizontal portion 121 by a predetermined length to connect with the second rear wall portion 122. Opposite insides of the guide walls 123 and 124 have guide ribs 123a and 124a, respectively, to guide loading of the HDD 1. The guide ribs 123a and 124a have a thickness corresponding to that of the sliding grooves 1a and 1b formed at opposite sides of the HDD 1 to prevent the HDD 1 from loading as the up and down thereof are reversed, that is, to prevent the HDD 1 from being loaded improperly.

The connector 20 includes a flexible printed circuit (FPC) part 21 and a plurality of connecting pins 22 formed at one side of the FPC part 21. The number of connecting pins 22 corresponds to those of the recording medium, which is preferably a hard disk drive or CF memory card. The connector 20 is engaged with the second rear wall portion 122 of the second frame 120 as the FPC part 21 is passed through the second opening 121a formed on the second horizontal portion 121. Preferably, as shown in FIG. 2, the connector 20 is supported as closely contacted with the second rear wall portion 122 by a contact bracket 23 that is engaged with the second rear wall portion 122 by fasteners, such as screws. Accordingly, the contact bracket 23 includes an opening 23a through which the plurality of connecting pins 22 protrude. Therefore, the HDD 1 is slidingly inserted between the first frame and the second frame 110 and 120 to be directly connected with the connector 20.

On a rear side of the connecting pin 22, a reinforcement plate 24 is further formed to substantially prevent transformations or damages.

The unloading unit 30 separates the HDD 1 that is loaded to the loading frame 10 and connected to the connector 20 from the connector 20 and unloads the HDD 1 from the loading frame 10 by a predetermined distance. The unloading unit 30 includes a rotating unit 31 that is rotatably connected to the first frame 110 and pushes the HDD 1 to separate the HDD 1 from the connector 20 while rotating, and a sliding unit 35 that is reciprocally movably engaged with the loading frame 10 to rotate the rotating unit 31 when moving to one side.

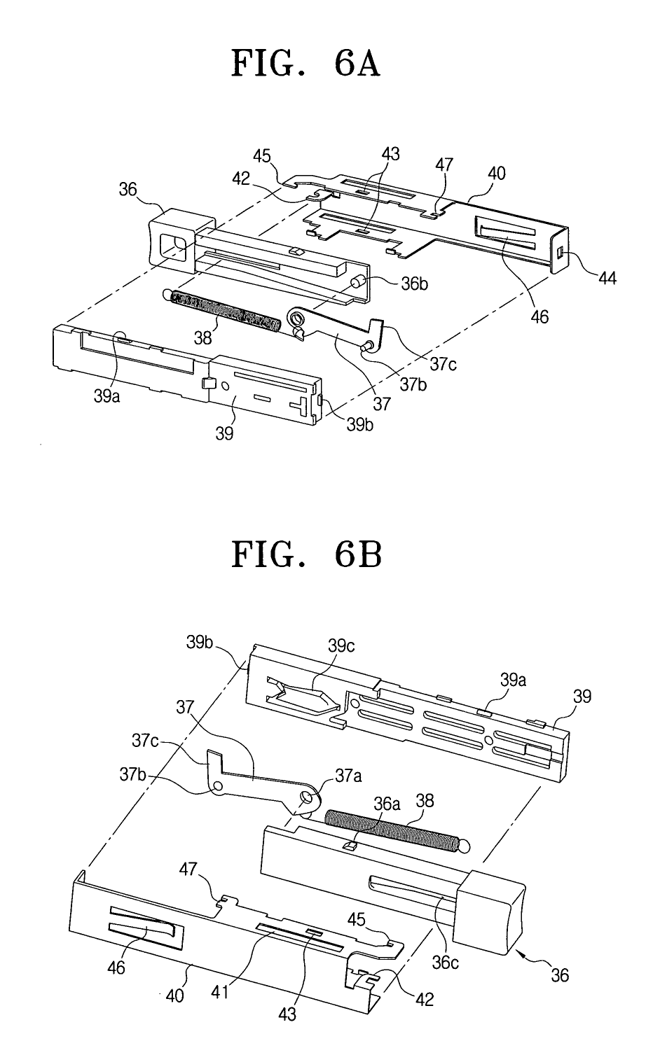

The rotating unit 31 includes a first rotating member 32 that is rotatably formed in the first frame 110 and a second rotating member 33 that is rotated in association with the first rotating member 32. Each of the rotating members 32 and 33 has gear portions 32a and 33a that mesh with each other. When the second rotating member 32 is pushed and rotated by the sliding unit 35, the second rotating member 33 is also rotated simultaneously. As shown in FIGS. 5A and 5B, the first and the second rotating members 32 and 33 are disposed to simultaneously push opposite ends of the HDD 1 so that the HDD 1 may be substantially prevented from receiving a preponderant force only at one side. The first and the second rotating members 32 and 33 have pressurizing portions 32b and 33b to push the HDD 1 outwardly. The first rotating member 32 has an extension portion 32c that extends toward the sliding unit 35 and interferes with the sliding unit 35 to receive a rotating force. Each rotating center of the first and the second rotating members 32 and 33 is supported by the first frame 110 based on the connection members 34, such as stud pins. The first and the second rotating members 32 and 33 may be made of metal materials to become slimmer and to substantially prevent transformations.

After pushing out the HDD 1 in association with the sliding unit 35, the first and the second rotating members 32 and 33 maintain the present positions. Accordingly, when the HDD is loaded to the loading frame 10, the first and the second rotating members 32 and 33 are pushed by the loaded HDD 1 to return to the original positions.

The first rotating member 32 has a protruding portion 32d exposed outside of the loading frame 10 through a first opening portion 115 formed in the first frame 110. The protruding portion 32d protrudes outside of the loading frame 10 by a predetermined distance so that a user may manually operate the protruding portion 32d to rotate the first rotating member 32 when the sliding unit 35 is misoperated or broken. The protruding portion 2d is provided for emergency operation of the loading and unloading apparatus.

The sliding unit 35 includes a sliding bar 36 formed slidingly on the loading frame 10 in the first direction A and the second direction B that are opposite to each other, an interference lever 37 moving together with the sliding bar 36 to interfere with the rotating unit 31 to be rotated, a spring 38 to elastically pressurize the sliding bar 36 in the second direction B, a cam member 39 to guide a movement of the interference lever 37, and a cover member 40.

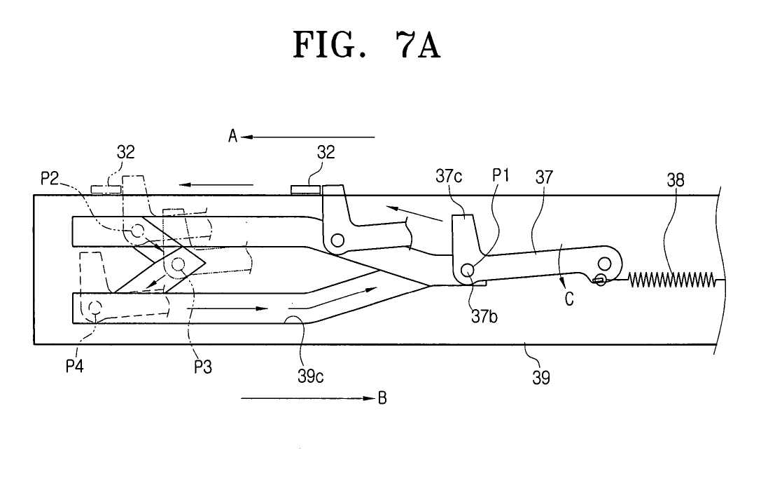

The sliding bar 36 is slidingly engaged with the cover member 40. As shown in FIGS. 6A and 6B, the sliding bar 36 has a guide protrusion 36a while the cover member 40 has a guide slit 41 to receive the guide protrusion 36a. One end of the sliding bar 36 is exposed to a leading end of the loading frame 10, that is, an entrance 10a in which the HDD 1 is inserted. An opposite end of the sliding bar 36 has a rotating pin 36b to rotatably engage the interference lever 37. The rotating pin 36b is moved together with the sliding bar 36 as connected with one end of the interference lever 37.

One end of the interference lever 37 has a connection opening 37a to be connected with the rotating pin 36b, and the other end thereof has a cam pin 37b connected with the cam member 39 to be guided. The other end of the interference lever 37 has also a contact portion 37c bent by a predetermined height to push and rotate the rotating unit 31, that is, the first rotating member 32, when moving in the direction A.

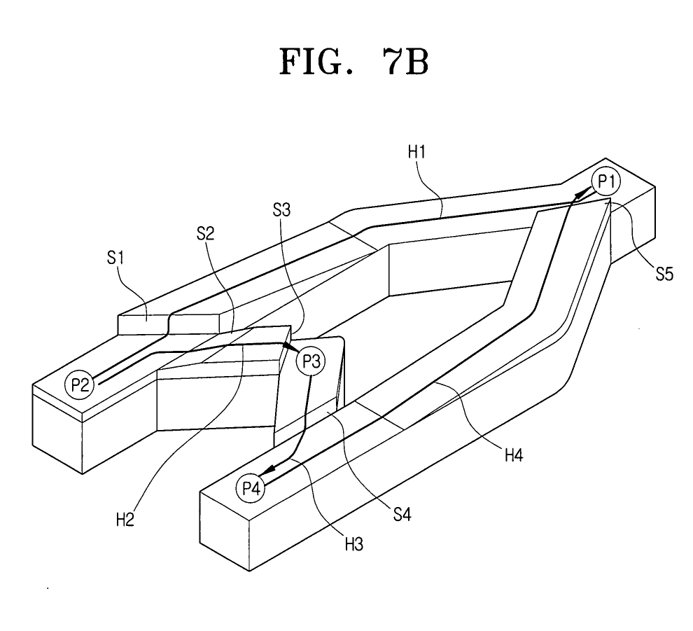

One end of the interference lever 37 is connected with the spring 38. The spring 38 is connected with the cover member 40 to push the interference lever 37 in direction C and simultaneously elastically pressurize the interference lever 37 in direction B as shown in FIG. 7A. Accordingly, the sliding bar 36 is pressurized in direction B, that is, the initial position, by the spring 38 and the interference lever 37, and the interference lever 37 is elastically pressurized in direction C, that is, in a direction to be moved away from a position in which the contact portion 37c interferes with the first rotating member 32. The other end of the spring 38 is connected to a hook 42 formed at the cover member 40. The sliding bar 36 has a slit 36c that is formed by a predetermined length and through which the hook 42 may pass without interferences.

The cam member 39 is engaged with the cover member 40 by a so-called one touch type. On side surfaces of the cam member 39, locking protrusions 39a and 39b are formed. The locking protrusions 39a and 39b are locked in locking holes 43 and 44 of the cover member 40. Accordingly, the cam member 39 is fixed onto the cover member 40 and the sliding bar 36 is slid between the cover member 40 and the cam member 39. When the sliding bar 36 is slid, the interference lever 37 is guided by the cam member 39 to interfere with the first rotating member 32 or to return to the original position.

The cam member 39 has a cam slit 39c to guide movement of the cam pin 37b. The cam slit 39c is configured as a closed loop of a certain shape. As shown in FIGS. 7A and 7B, as the sliding bar 36 is firstly pushed in the first direction A from the initial position and released, the cam pin 37b moves along a first passage H1 from a point P1 to a point P2 and then along a second passage H2 to a point P3 by a restitution force of the spring 38. Thereafter, as the sliding bar 36 is secondly pushed in direction A and released, the cam pin 37b moves along a third passage H3 to a point P4 and returns along a fourth passage H4 to the point P1 by a restitution force of the spring 38. When the interference lever 37 moves from the point P1 to the point P2, a rotating angle of the interference lever 37 is adjusted by the first passage H1 so that the contact portion 37c moves to a position where the contact portion 37c may interfere with the first rotating member 32. Accordingly, while moving from the point P1 to the point P2, the contact portion 37c pushes and rotates the first rotating member 32 in the direction A to unload the HDD 1 by a predetermined distance.

When the cam pin 37c of the interference lever 37 is released when pushed to the point P2, the cam pin 37c is locked by a stepped portion S1 in the first passage H1 on the way back to the second direction B by the restitution force of the spring 38, and guided to the second passage H2, moved to the point P3 and finally stopped. Then, as shown in FIG. 7A, the rotating angle of the interference lever 37 is further increased so that the contact portion 37c is moved to a position lower than that of the first rotating member 32, that is, to a position where the contact portion 37c does not interfere with the first rotating member 32.

Because stepped portion S3 is also formed on the second passage H2 (after stepped portion S2), even when pushed in the direction A, the cam pin 37c is not returned to the point P2 but guided by the stepped portions S2 and S3 to be finally guided to the point P4. Because a stepped portion S4 is also formed on the third passage H3, the cam pin 37b returned from the point P4 toward the direction B, is guided by the stepped portion S4 to be guided along the fourth passage H4 to the point P1. Additionally, because a stepped portion S5 is formed between the fourth passage H4 and the first passage H1, the cam pin 37b is guided at the point P1 by the stepped portion S5 to be directly moved to the point P2.

As described above, inner bottom surfaces of the passages H1, H2, H3 and H4 of the cam slit 39c, that is, the cam surfaces have certain stepped portions S1, S3, S4 and S5. Therefore, the cam pin 37b may be repeatedly rounded in only one direction as the sliding bar 36 is pushed. Except for when the cam pin 37b is moved from the original position, that is, the point P1 to the point P2, the contact portion 37c does not interfere with the first rotating member 32. Accordingly, the rotating member 32 may be naturally moved to the initial position, that is, the position as pushed by the loaded HDD 1 as shown in FIG. 5A.

To elastically pressurize the interference lever 37 toward the cam slit 39c, an elastic piece 46 is formed integrally with the cover member 40 so that the cam pin 37c is in close contact with the cam surfaces of the cam slit 39c.

The cover member 40 is made of a metal material and fixed onto the loading frame 10 to support the cam member 39 and the sliding bar 36. To this end, connection portions 45 and 47 are formed in certain shapes at the cover member 40 to engage the cover member 40 with the loading frame 10.

Hereinafter, processes of loading and unloading a HDD are explained using a loading and unloading apparatus for a HDD according to an exemplary embodiment of the present invention.

FIG. 5A illustrates when the HDD 1 is inserted and loaded into the loading frame 10. In this position, the first rotating member 32 is located in the initial position, that is, the position shown in a solid line of right side of FIG. 7A. The cam pin 37b of the interference lever 37 is located on the point P1 or the point P3 of FIG. 7A. When a user pushes the sliding bar 36 in the direction A as the cam pin 37b is located on the point P1, the cam pin 37b pushes the first member 32 in the direction A while moved along the first passage H1 to the point P2. When the sliding bar 36 is pushed and released, the cam pin 37b is moved along the second passage H2 to the point P3 as described above.

As the first rotating member 32 is rotated in the direction A, the second rotating member 33 is accordingly rotated. While rotated, the first rotating member 32 and the second rotating member 33 push end portions of the HDD 1 in the direction B by a predetermined distance as shown in FIG. 5B. Then, as the HDD 1 is disengaged from the connector 20 and unloaded from the loading frame 10 by a predetermined distance so that a user may pull out the HDD 1 with their hands.

When the cam pin 37b is located on the point P3 as described above, the contact portion 37c is rotated as not interfered by the rotating member 32. Accordingly, if the HDD 1 is re-slid and loaded into the loading frame 10 as the cam pin 37b is located on the point P3, the first and the second rotating members 32 and 33 are pushed by the end portions of the HDD 1 and returned to the initial positions, that is, the positions shown in a solid line of FIG. 7A. At this time, the first rotating member 32 may be returned to the initial position as not interfered by the interference lever 37.

In the above position, when the HDD 1 is tried to be unloaded again, the sliding bar 36 is pushed in the direction A and released. Then, the cam pin 37b located on the point P3 is moved along the third passage H3 to the point P4 and returned along the fourth passage H4 to the point P1 by the restitution force of the spring 38 as described with reference to FIG. 7B. At this time, the sliding bar 36 protrudes by the longest length from the loading frame 10. Accordingly, when the sliding bar 36 is pushed in the direction A again as the cam pin 37b is returned to the point P1, the cam pin 37b is moved along the first passage H1 and the contact portion 37c of the interference lever 37 interferes with the first rotating member 32 to be pushed in the direction A as aforementioned. Accordingly, while rotating, the first and the second rotating members 32 and 33 push the HDD 1 in the unloading direction B.

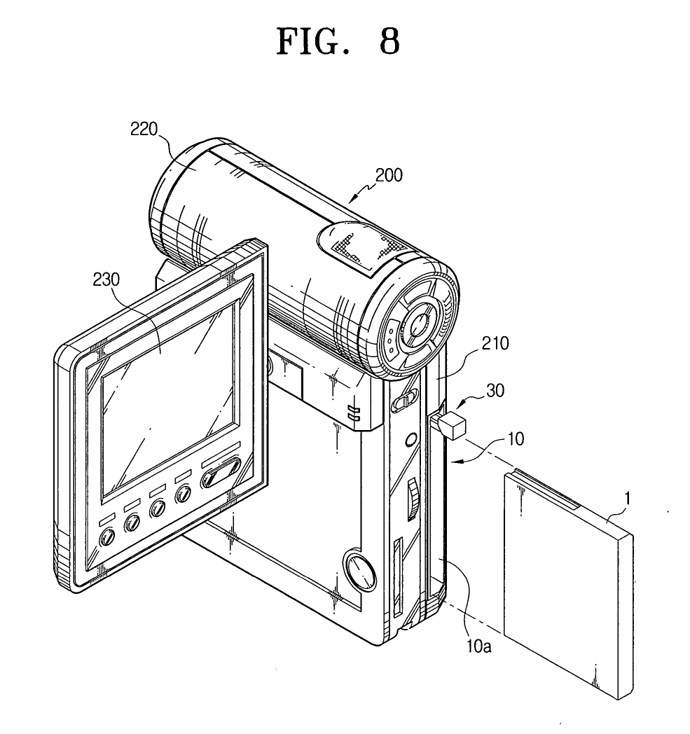

FIG. 8 schematically illustrates an image photographing and reproducing apparatus 200 employing a loading and unloading apparatus for a HDD. Referring to FIG. 8, the image photographing and reproducing apparatus 200 includes a general camcorder and a digital camera and has a main body 210, a camera part 220, a display part 230 and a loading and unloading apparatus for a HDD.

The camera part 220 is disposed on a substantial upper portion of the main body 210 to obtain an image. The configuration, structure and operation of the camera part 220 may be easily comprehended from known arts so that detailed description thereof is omitted for the sake of brevity.

The display part 230 includes a liquid crystal display (LCD) panel and may be formed to be rotatable, openable and closable to the main body 210. The display part 230 may be fixed onto the main body 210 as a general digital camera.

The loading and unloading apparatus for a HDD is engaged with one side of the main body 210 to expose a part of the apparatus. The loading frame 10 is engaged with the main body 210 to expose the entrance 10a in which the HDD 1 is inserted, and the sliding unit 30 is connected to be exposed to the outside of the main body 210. Accordingly, as aforementioned, the HDD 1 loaded in the loading frame 10 may be unloaded as the sliding unit 30 is pushed. The loading and unloading apparatus for a HDD installed in the main body 210 is described above with reference to FIGS. 1 through 7B.

As described above, the loading and unloading apparatus for a HDD according to an exemplary embodiment of the present invention may be applied to all recording media, including a 1-inch hard disk drive or a CF memory card. The recording media may be detachably installed to an electronic device, such as an image photographing and reproducing apparatus using the loading and unloading apparatus for a HDD according to an exemplary embodiment of the present invention.

According to an exemplary embodiment of the present invention, two rotating members simultaneously push left and right sides of the HDD to smoothly unload the HDD. Therefore, the distortion of the HDD may be substantially prevented.

Additionally, according to an exemplary embodiment of the present invention, the loading frame has a structure to elastically, upwardly, downwardly, left and right support the HDD to the loading frame to substantially prevent the HDD from shocks and vibrations from up, down, left and right.

While the invention has been shown and described with reference to certain embodiments thereof, it will be understood by those skilled in the art that various changes in form and details may be made therein without departing from the spirit and scope of the invention as defined by the appended claims.

What is claimed is:

1. A loading and unloading apparatus for a recording medium to detachably load a recording medium to an electronic device, comprising:
a loading frame installed in the electronic device and with which the recording medium is slidingly engaged;
a connector installed on the loading frame;
an unloading unit slidingly inserted in the loading frame to unload the recording medium connected to the connector by a predetermined distance to separate the recording medium from the connector.

2. The loading and unloading apparatus for a recording medium as claimed in claim 1, wherein the loading frame includes
a first frame and a second frame that are engaged to face each other to slidingly insert and unload the recording medium therebetween.

3. The loading and unloading apparatus for a recording medium as claimed in claim 2, wherein the first frame includes
a pair of first elastic pieces to elastically support opposite sides of the recording medium.

4. The loading and unloading apparatus for a recording medium as claimed in claim 3, wherein the first frame includes
a pair of second elastic pieces that elastically support one surface of the recording medium to restrain up and down movements.

5. The loading and unloading apparatus for a recording medium as claimed in claim 2, wherein
the first frame is made of a metal material.

6. The loading and unloading apparatus for a recording medium as claimed in claim 2, wherein
the second frame is engaged with the first frame to obtain a space to insert the recording medium therebetween, and has an opening to pass the connector therethrough.

7. The loading and unloading apparatus for a recording medium as claimed in claim 6, wherein
opposite sides of the recording medium have sliding grooves of different shapes, respectively, and the second frame has guide ribs corresponding to each of the sliding grooves of the recording medium.

8. The loading and unloading apparatus for a recording medium as claimed in claim 1, wherein the connector includes
a flexible printed circuit (FPC) part connected to the loading frame;
a connecting pin formed at an end portion of the FPC part to be located inside of the loading frame; and
a contact bracket that fixes the connecting pin to be in close contact with the inside of the loading frame.

9. The loading and unloading apparatus for a recording medium as claimed in claim 8, wherein the connector includes
a reinforcement plate engaged with an end portion of the FPC part to oppose the connecting pin.

10. The loading and unloading apparatus for a recording medium as claimed in claim 2, wherein the connector includes
a flexible printed circuit (FPC) part connected to the loading frame;
a connecting pin formed at an end portion of the FPC part to be located inside of the loading frame; and
a contact bracket that fixes the connecting pin to be in close contact with the inside of the loading frame.

11. The loading and unloading apparatus for a recording medium as claimed in claim 10, wherein the connector includes
a reinforcement plate engaged with an end portion of the FPC part to oppose the connecting pin.

12. The loading and unloading apparatus for a recording medium as claimed in claim 1, wherein the unloading unit includes
a rotating unit rotatably engaged with the loading frame to push and unload the recording medium loaded on the loading frame by a predetermined distance when rotated in one direction; and
a sliding unit reciprocally and movably engaged with the loading frame to rotate the rotating unit in the one direction when moved in a loading direction of the recording medium.

13. The loading and unloading apparatus for a recording medium as claimed in claim 12, wherein the rotating unit includes
a first rotating member rotatably engaged with the loading frame and one end of which is moved in association with the sliding unit; and
a second rotating member rotatably engaged with the loading frame and rotated in association with the first rotating member.

14. The loading and uploading apparatus for a recording medium as claimed in claim 13, wherein
the first rotating member and the second rotating member each have pressurizing portions that are bent to substantially simultaneously push opposite edges of the recording medium.

15. The loading and unloading apparatus for a recording medium as claimed in claim 14, wherein
the first rotating member and the second rotating member are rotatably engaged with the loading frame so as to be returned to original positions by the recording medium loaded on the loading frame from positions where the recording medium is unloaded.

16. The loading and unloading apparatus for a recording medium as claimed in claim 12, wherein the sliding unit includes
a sliding bar reciprocally slidingly engaged in first and second directions with the loading frame;
an interference lever rotatably engaged with one end of the sliding bar and interferes with the rotating unit to be rotated when moved in the first direction;
a spring that elastically supports the sliding bar in the second direction;
a cam member that changes a rotating angle to guide the interference lever to not be interfered by the rotating member when the interference lever is returned to the second direction; and
a cover member that supports the sliding bar and the cam member and is engaged with the loading frame.

17. The loading and uploading apparatus for a recording medium as claimed in claim 16, wherein
one end of the spring is engaged with the cover member and the other end of the spring is engaged with the interference lever, and the interference lever is pressurized in a direction to be moved out of a position where the interference lever interferes with the rotating unit by an elastic force of the spring.

18. The loading and uploading apparatus for a recording medium as claimed in claim 16, wherein
the other end of the interference lever comprises a cam pin which is inserted in a cam slit of the cam member to be guided and a contact portion which is bent to contact and rotate the rotating unit when moved in the first direction.

19. The loading and unloading apparatus for a recording medium as claimed in claim 16, wherein the cam member includes
a cam slit that is connected to a cam pin formed at the other end of the interference lever to guide the cam pin in one direction along a certain passage; and
a cam surface formed in a certain shape on a bottom surface of the cam slit to guide the interference lever to move only in one direction of the cam slit in accordance with reciprocal movement of the sliding bar.

20. The loading and unloading apparatus for a recording medium as claimed in claim 19, wherein
when the sliding bar is firstly pushed in the first direction and released, the cam surface guides the cam pin of the interference lever to move in the first direction, rotates the rotating unit and moves out of an interference range of the rotating unit; and
when the sliding bar is secondly pushed in the first direction and released, the cam surface guides the cam pin to move in the first direction and then in the second direction and returns to an initial position.

21. The loading and unloading apparatus for a recording medium as claimed in claim 16, wherein the cover member includes
an elastic piece that elastically pressurizes the interference lever toward the cam member.

22. The loading and unloading apparatus for a recording medium as claimed in claim 1, wherein
the recording medium is a hard disk drive.

23. The loading and unloading apparatus for a recording medium as claimed in claim 1, wherein
the recording medium is a compact flash memory card.

24. An image photographing and reproducing apparatus, comprising:
an image photographing apparatus body;
a camera part formed at the body to photograph an image;
a display unit formed at the body to display the image photographed by the camera part; and
a loading and unloading apparatus for a recording medium that is formed at the body to detachably load a recording medium that records image data photographed by the camera part and reproduces the recorded data.

25. The image photographing and reproducing apparatus as claimed in claim 24, wherein the loading and unloading apparatus for a recording medium includes
a loading frame that is installed in the electronic device and with which the recording medium is slidingly engaged;
a connector formed on the loading frame; and
an unloading unit that is slidingly inserted in the loading frame and unloads the recording medium connected to the connector by a predetermined distance to separate the recording medium from the connector.

26. The image photographing and reproducing apparatus as claimed in claim 25, wherein the loading frame includes
a first frame and a second frame that are engaged to face each other to slidingly insert and unload the recording medium therebetween.

27. The image photographing and reproducing apparatus as claimed in claim 26, wherein the first frame includes
a pair of first elastic pieces to elastically support opposite sides of the recording medium; and
a pair of second elastic pieces that elastically support one surface of the recording medium to restrain up and down movements.

28. The image photographing and reproducing apparatus as claimed in claim 26, wherein
the second frame is engaged with the first frame to obtain a space to insert the recording medium therebetween, and has an opening to pass the connector therethrough.

29. The image photographing and reproducing apparatus as claimed in claim 28, wherein
opposite sides of the recording medium have sliding grooves having different shapes, respectively, and the second frame has guide ribs corresponding to each of the sliding grooves of the recording medium.

30. The image photographing and reproducing apparatus as claimed in claim 25, wherein the connector includes
a flexible printed circuit (FPC) part connected to the loading frame;
a connecting pin formed at an end portion of the FPC part to be located inside the loading frame; and
a contact bracket that fixes the connecting pin to be in close contact with the inside of the loading frame.

31. The image photographing and reproducing apparatus as claimed in claim 26, wherein the connector includes
a flexible printed circuit (FPC) part connected to the loading frame;
a connecting pin formed at an end portion of the FPC part to be located inside of the loading frame; and
a contact bracket that fixes the connecting pin to be in close contact with the inside of the loading frame.

32. The image photographing and reproducing apparatus as claimed in claim 25, wherein the unloading unit includes
a rotating unit that is rotatably engaged with the loading frame to push and unload the recording medium loaded on the loading frame by a predetermined distance when rotated in one direction; and
a sliding unit that is reciprocally and movably engaged with the loading frame to rotate the rotating unit in the one direction when moved in a loading direction of the recording medium.

33. The image photographing and reproducing apparatus as claimed in claim 32, wherein the rotating unit includes
a first rotating member that is rotatably engaged with the loading frame and one end of which is moved in association with the sliding unit; and
a second rotating member that is rotatably engaged with the loading frame and rotated in association with the first rotating member.

34. The image photographing and reproducing apparatus as claimed in claim 33, wherein
the first rotating member and the second rotating member each have pressurizing portions that are bent to substantially simultaneously push opposite edges of the recording medium.

35. The image photographing and reproducing apparatus as claimed in claim 32, wherein the sliding unit includes
a sliding bar that is reciprocally slidingly engaged in first and second directions with the loading frame;
an interference lever that is rotatably engaged with one end of the sliding bar and that interferes with the rotating unit to be rotated when moved in the first direction;
a spring that elastically supports the sliding bar in the second direction;
a cam member that changes a rotating angle to guide the interference lever to not be interfered with by the rotating member when the interference lever is returned in the second direction; and
a cover member that supports the sliding bar and the cam member and is engaged with the loading frame.

36. The image photographing and reproducing apparatus as claimed in claim 35, wherein
one end of the spring is engaged with the cover member and the other end of the spring is engaged with the interference lever, and the interference lever is pressurized in a direction to be moved out of a position where the interference lever interferes with the rotating unit by an elastic force of the spring.

37. The image photographing and reproducing apparatus as claimed in claim 35, wherein the other end of the interference lever includes
a cam pin that is inserted in a cam slit of the cam member to be guided and a contact portion that is bent to contact and rotate the rotating unit when moved in the first direction.

38. The image photographing and reproducing apparatus as claimed in claim 35, wherein the cam member includes
a cam slit that is connected to a cam pin formed at the other end of the interference lever to guide the cam pin in one direction along a certain passage; and
a cam surface formed in a certain shape on a bottom surface of the cam slit to guide the interference lever to move only in one direction of the cam slit in accordance with reciprocal movement of the sliding bar.

39. The image photographing and reproducing apparatus as claimed in claim 38, wherein
when the sliding bar is firstly pushed in the first direction and released, the cam surface guides the cam pin of the interference lever to move in the first direction, to rotate the rotating unit and to move out of an interference range of the rotating unit; and
when the sliding bar is secondly pushed in the first direction and released, the cam surface guides the cam pin to move in the first direction and then in the second direction and to return to an initial position.

40. The image photographing and reproducing apparatus as claimed in claim 24, wherein
the recording medium is a removable hard disk drive.

41. The image photographing and reproducing apparatus as claimed in claim 24, wherein
the recording medium is a removable compact flash type memory card.
